(19) United States
(12) Patent Application Publication
(10) Pub. No.: US 2025/0384348 A1
(43) Pub. Date: Dec. 18, 2025

(54) SYSTEMS AND METHODS FOR HYPERPARAMETER OPTIMIZATION

(71) Applicant: Kinaxis Inc, Ottawa (CA)

(72) Inventors: Anthony John Arena, Toronto (CA); Kevin Wye-Lim Chan, Toronto (CA); Yousra Mohamed, Mississauga (CA); Behrouz Haji Soleimani, Ottawa (CA)

(73) Assignee: Kinaxis Inc, Ottawa (CA)

(21) Appl. No.: 19/241,030

(22) Filed: Jun. 17, 2025

Related U.S. Application Data
(60) Provisional application No. 63/660,781, filed on Jun. 17, 2024.

(51) Int. Cl. G06N 20/00

(52) U.S. Cl. CPC G06N 20/00

(57) ABSTRACT

Methods and systems for improving the efficiency of hyperparameter tuning by generalizing run results across different segments of data. Segments are grouped by segment data metrics, to produce segment clusters. Hyperparameter tuning is run for a cluster medoid and resulting hyperparameters are used for training machine learning models for the segments corresponding to the cluster.

### CROSS-REFERENCE TO RELATED APPLICATIONS

This application claims priority to U.S. Provisional Patent Application 63/660,781 filed on Jun. 17, 2024, which is incorporated herein in its entirety, by reference.

### BACKGROUND

One of the most time consuming steps of training a machine learning algorithm is hyperparameter tuning. Hyperparameter tuning involves choosing a set of optimal hyperparameters for a machine learning algorithm. A hyperparameter is a machine learning parameter whose value is chosen before a machine learning algorithm is trained; the values of the hyperparameter control the learning process. These include design choices that control the machine learning model size, complexity, and architecture, including the number of layers, number of neurons in each layer, and so on, for neural network models. For gradient boosted decision trees, this includes maximum number of leaves, number of iterations, and so on.

While hyperparameter tuning is a standard process to optimize models to achieve better accuracy, it comes at a costly price. Hyperparameters of a model cannot be learned from a dataset and must be provided before the model training stage. For big data, conducting hyperparameter tuning is not feasible for each data series. Hyperparameter tuning is performed with the use of tuning software and is usually a prolonged and resource intensive process. For example, to train a single machine learning model, hyperparameters for that model must be selected prior thereto. For example, hundreds of different sets of hyperparameters are tried, and for each trial, a machine learning model is trained and tested for accuracy. The hyperparameter of the most accurate model is selected for training the final machine learning model. A validation process also adds to the time complexity of hyperparameter tuning, as each trial validates the performance of the chosen hyperparameters on multiple splits of the data.

In addition to hyperparameter tuning, processing of enormous amounts of data for the purpose of machine learning is a resource intensive process. As an example, when data is cast as a large number of sets of time-series data, traditional time-series data forecasting methods, including statistical forecasting methods, predict each time series separately. For a large number of time-series data sets, forecasting becomes a complicated task, since results based on hundreds of thousands of times-series data are to be forecasted. As such, using machine learning techniques for forecasting requires training hundreds of thousands of machine learning models. This is both resource intensive and time consuming from a computational perspective.

There is a need for optimizing hyperparameter tuning that reduces the amount of computing resources and processing time needed for hyperparameter tuning. In addition, there is a need to address the enormous amounts of data used for machine learning training, especially where the original data size is often beyond available computer resources.

### BRIEF SUMMARY

Segmenting data into groups based on a common attribute is one method for fitting the data into limited memory on multiple CPUs, where the original data size goes beyond available computing resources, thereby producing a model for each segment of data for forecasting multiple time-series data.

Furthermore, in big data, conducting hyperparameter tuning for every data segment is often not practical as it is a time consuming and resource intensive step. Disclosed herein are methods and systems for improving the efficiency of hyperparameter tuning by generalizing run results across different segments of data. Segments can be grouped by segment data metrics to produce segment clusters. Hyperparameter tuning can then be executed for a cluster medoid and the resulting hyperparameters may be used for training machine learning models for the segments corresponding to the cluster. Bypassing the step of hyperparameter tuning for the majority of segments significantly reduces the amount of time for tuning large numbers of machine learning models.

In one aspect, a computing apparatus is provided. The apparatus includes a processor. The computing apparatus also includes a memory storing instructions that, when executed by the processor, configure the apparatus to: receive a plurality of segment data; determine data metrics for each segment data; cluster data points into a plurality of clusters, the data points indicative of a subset of the data metrics for each segment data; determine a preliminary medoid of each cluster, select a cluster; tune a set of hyperparameters using segment data corresponding to a medoid of the cluster; and train a machine learning model on each segment data in the cluster using the set of hyperparameters associated with the cluster.

When tuning the set of hyperparameters, the computing apparatus may also be configured to obtain the preliminary medoid of the cluster; and determine whether segment data associated with the preliminary medoid is sufficient for tuning. Where the segment data associated with the preliminary medoid is sufficient, the apparatus may be configured to tune the set of hyperparameters on the segment data associated with the preliminary medoid. Where the segment data associated with the preliminary medoid is insufficient, the apparatus may be configured to: sequentially select a data point adjacent to the preliminary medoid until segment data associated with the adjacent data point is sufficient for tuning; and tune the set of hyperparameters on the segment data associated with the adjacent data point. The computing apparatus may also include where the preliminary medoid is a data point closest a centroid of the cluster. The computing apparatus may be further configured to forecast an item using a trained machine learning model. The machine learn model may include: neural networks, decision trees, linear regression, and support vector machines, hidden Markov models, k-means, hierarchical clustering, Gaussian mixture models, temporal difference learning, deep adversarial networks, and Q-learning. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: receive a plurality of segment data; determine data metrics for each segment data; cluster data points into a plurality of clusters, the data points indicative of a subset of the data metrics for each segment data; determine a preliminary medoid of each cluster; select a cluster; tune a set of hyperparameters using segment data corresponding to a medoid of the cluster; and train a machine learning model on each segment data in the cluster using the set of hyperparameters associated with the cluster.

When tuning the set of hyperparameters, the computer-readable storage medium may also include instructions that further configure the computer to obtain the preliminary medoid of the cluster; and determine whether segment data associated with the preliminary medoid is sufficient for tuning. Where the segment data associated with the preliminary medoid is sufficient, the computer may be configured to tune the set of hyperparameters on the segment data associated with the preliminary medoid. Where the segment data associated with the preliminary medoid is insufficient, the computer may be configured to: sequentially select a data point adjacent to the preliminary medoid until segment data associated with the adjacent data point is sufficient for tuning; and tune the set of hyperparameters on the segment data associated with the adjacent data point.

The computer-readable storage medium may also include where the preliminary medoid is a data point closest a centroid of the cluster. The computer-readable storage medium may also include instructions that further configure the computer to forecast an item using a trained machine learning model. The machine learning model may include: neural networks, decision trees, linear regression, and support vector machines, hidden Markov models, k-means, hierarchical clustering, Gaussian mixture models, temporal difference learning, deep adversarial networks, and Q-learning. Other technical features may be readily apparent to one skilled in the art from the following figures, descriptions, and claims.

In one aspect, a computer-implemented method is provided that includes: receiving, by a processor, a plurality of segment data; determining, by the processor, data metrics for each segment data; clustering, by the processor, data points into a plurality of clusters, the data points indicative of a subset of the data metrics for each segment data; determining, by the processor, a preliminary medoid of each cluster; selecting, by the processor, a cluster; tuning, by the processor, a set of hyperparameters using segment data corresponding to a medoid of the cluster; and training, by the processor, a machine learning model on each segment data in the cluster using the set of hyperparameters associated with the cluster.

The computer-implemented method may also include where tuning the set of hyperparameters includes: obtaining, by the processor, the preliminary medoid of the cluster; and whether segment data associated with the preliminary medoid is sufficient for tuning. Where the segment data associated with the preliminary medoid is sufficient, the computer-implement method may also include: tuning, by the processor, the set of hyperparameters on the segment data associated with the preliminary medoid. Where the segment data associated with the preliminary medoid is insufficient, the computer-implement method may also include: selecting sequentially, by the processor, a data point adjacent to the preliminary medoid until segment data associated with the adjacent data point is sufficient for tuning; and tuning, by the processor, the set of hyperparameters on the segment data associated with the adjacent data point.

The computer-implemented method may also include where the preliminary medoid is a data point closest a centroid of the cluster. The computer-implemented method may further include forecasting an item using a trained machine learning model. The machine learning model may include: neural networks, decision trees, linear regression, and support vector machines, hidden Markov models, k-means, hierarchical clustering, Gaussian mixture models, temporal difference learning, deep adversarial networks, and Q-learning. Other technical features may be readily apparent to one skilled in the art from the following figures, descriptions, and claims.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an exemplary environment within which an embodiment of hyperparameter optimization may operate.

FIG. 2 illustrates exemplary historical data in accordance with an embodiment.

FIG. 3 illustrates exemplary segment data in accordance with an embodiment.

FIG. 4 illustrates exemplary data metrics of segment data in accordance with an embodiment.

FIG. 5 shows exemplary clusters in 2-dimensional graph in accordance with an embodiment.

FIG. 6 illustrates a block diagram of a method for hyperparameter optimization in accordance with an embodiment.

FIG. 7 illustrates a block diagram of tuning subroutine in accordance with an embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification may be labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor(s) of a general purpose computer(s), special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification may be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

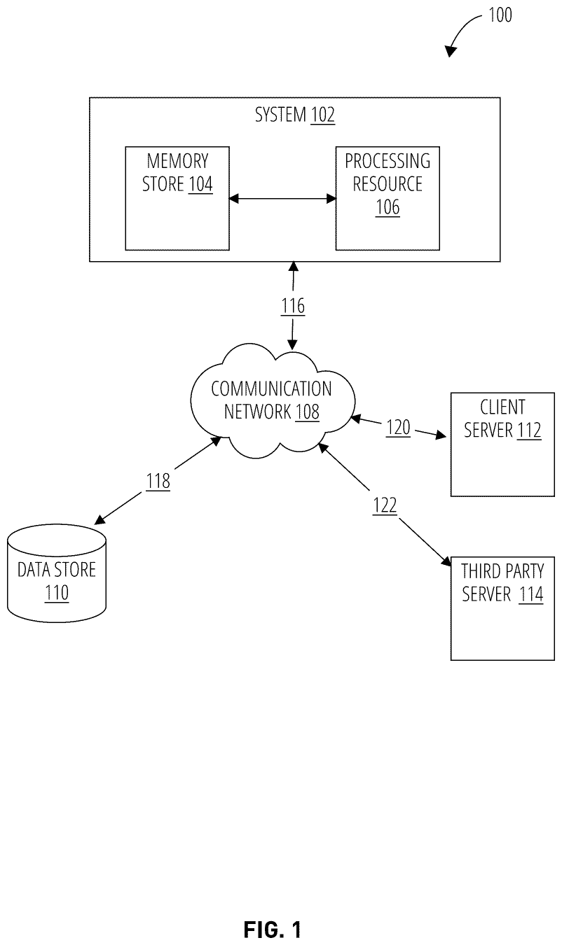

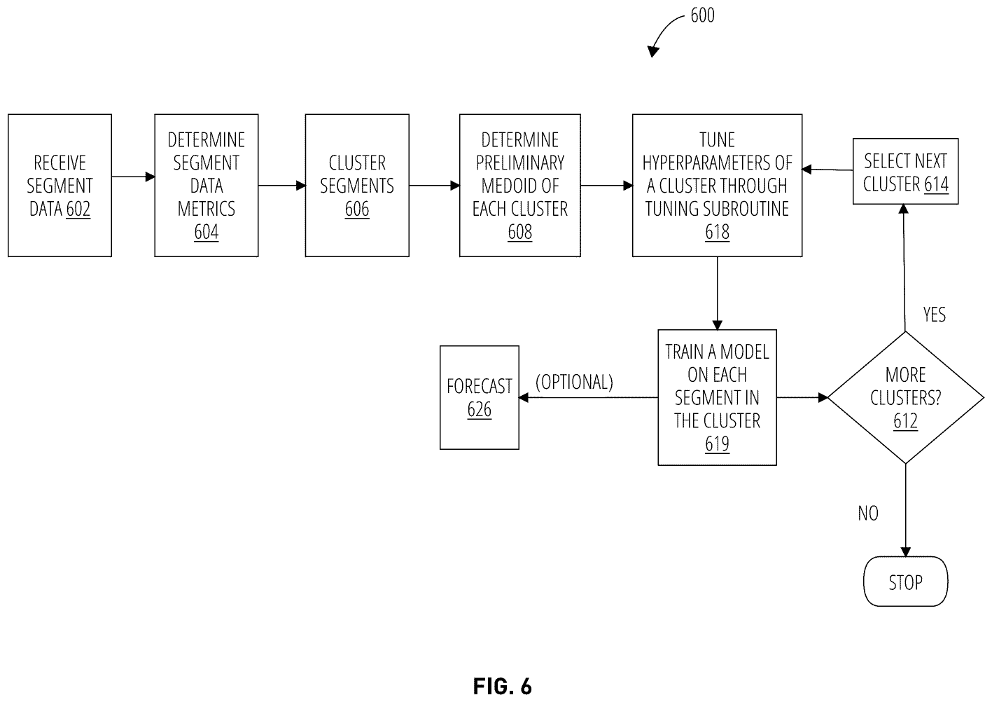

FIG. 1 illustrates an exemplary environment 100 within which an embodiment of hyperparameter optimization may operate. An exemplary method of hyperparameter optimization, illustrated in FIG. 6, can be described as carried out by system 102 shown in FIG. 1.

Environment 100 can include system 102, communication network 108, data store 110, client server 112 and third party server 114. System 102 can include memory store 104 and processing resource 106.

In some embodiments, system 102 can communicate with any one of data store 110, client server 112, and third party server 114 via communication network 108. While data store 110 is illustrated as separate from system 102, data store 110 can also be integrated into system 102, either as a separate component within system 102, or as part of memory store 104. A versioned database can refer to a database which provides numerous complete delta-based copies of an entire database. Each complete database copy represents a version. Versioned databases can be used for numerous purposes, including simulation and collaborative decision-making.

Environment 100 can also include additional features and/or functionality. For example, environment 100 can also include additional storage (removable and/or non-removable) including, but not limited to, magnetic or optical disks or tape. Such additional storage is illustrated in FIG. 1 by memory store 104. Storage media can include volatile and nonvolatile, removable and non-removable media implemented in any method or technology for storage of information such as computer-readable instructions, data structures, program modules or other data. Memory store 104 is an example of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 102. Any such non-transitory computer-readable storage media can be part of system 102.

Environment 100 can also include interfaces 116, 118, 120 and 122. Interfaces 116, 118, 120 and 122 can allow components of environment 100 to communicate with each other via communication network 108. For example, system 102 can communicate with data store 110 via communication network 108 using interface 116 and interface 118. System 102 can also communicate with client server 112 and third party server 114 via communication network 108 using interfaces 116 and 120, and interfaces 116 and 122, respectively. Non-limiting examples of interfaces 116, 118, 120 and 122 can include wired communication links such as a wired network or direct-wired connection, and wireless communication links such as cellular, radio frequency (RF), infrared and/or other wireless communication links. Interfaces 416, 418, 420 and 122, along with communication network 108, can allow system 102 to communicate with data store 110, client server 112 and third party server 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118, 120 and 122 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, communication network 108 and interface 118, system 102 can retrieve data from data store 110. The retrieved data can be saved in memory store 104. In some cases, system 102 can also include a web server, and can format resources into a format suitable to be displayed on a web browser. System 102 can then send requested data to client server 112 via interface 116, communication network 108 and interface 120.

When training data is cast as time-series data, traditional time-series data forecasting methods predict each time series separately. For a large number of time-series data sets, demand forecasting becomes a complicated task, since results based on hundreds of thousands of times-series data are to be forecasted. As such, using machine learning techniques for demand forecasting requires training hundreds of thousands of machine learning models. This is both resource intensive and time consuming from a computational perspective.

As an example, demand forecasting is commonly relied upon by retailers and manufacturers to ensure that an adequate supply of a product is in their stores and that there is enough inventory to meet customer demand. Sales of each item at each location can be cast as time-series data, which often includes sales data from the date of product introduction up to a current date (e.g., historical sales data). Traditional time-series data forecasting methods, including statistical forecasting methods, predict each time series separately. For a large retailer with hundreds of stores and thousands of items, demand forecasting is a complicated task. To predict the total demand of each item (referred to herein as a forecast item) per site, results in hundreds of thousands of times-series data to be forecasted, which is resource intensive and time consuming. That is, using machine learning techniques for demand forecasting requires training hundreds of thousands of machine learning models.

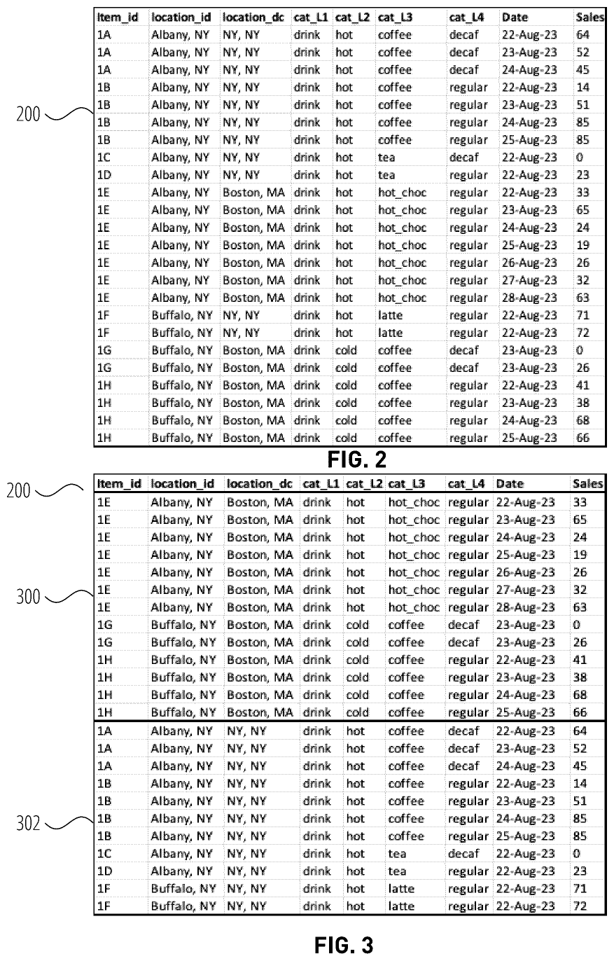

FIG. 2 illustrates exemplary historical data in accordance with an embodiment. Segmenting data into groups based on a common attribute is one method for fitting the data into limited memory on multiple CPUs, thereby producing a machine learning model for each segment of data for forecasting multiple time-series data.

Shown in FIG. 2 is example historical data 200, including 24 items having an item_id located at 24 stores indicated by location_id. Traditionally, for each item and each location, a machine learning model is trained for forecasting the forecast item. However, historical data 200 may be segmented according to a common attribute.

FIG. 3 illustrates exemplary segment data in accordance with an embodiment. In FIG. 3, attributes of exemplary data 200 are provided, including Item_Id, Location_Id, Location_dc (distribution center), cat_L1 (first category level of item), cat_L2 (second category level of item), cat_L3 (third category level of item), cat_L4 (fourth category level of item), date of sale and the number of sales of the item.

In FIG. 3, data 200 is segmented according to location_dc, which forms a plurality of segmented data, such as segment data 300 (for which Boston is the location_dc) and segment data 302 (for which New York is the location_dc). In this example, two machine learning models are built—one for each distribution centre data segment.

This example includes only 2 segments for descriptive purposes; however, a person of skill will appreciate that there can be hundreds, thousands or millions of segments available. Similarly, in this example, data is segmented on one attribute for descriptive purposes only, however a person of skill will appreciate data may be segmented based on any number of attributes. Segmenting time series data into groups based on a common attribute can reduce the number of machine learning models to be trained for forecasting multiple-time series data, thereby reducing computational resources and processing time. There still remains the issue of hyperparameter tuning.

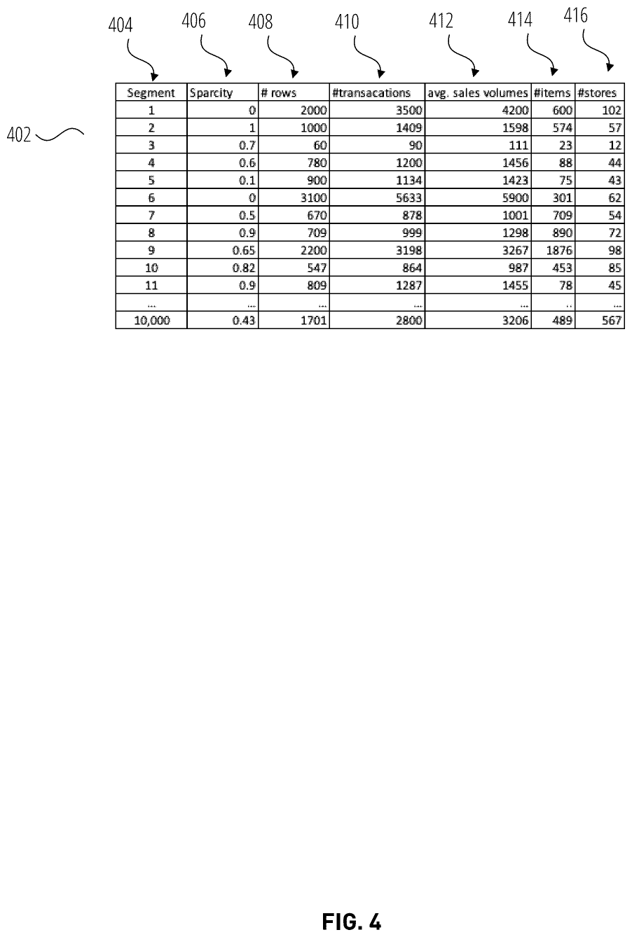

FIG. 4 illustrates exemplary data metrics of segment data in accordance with an embodiment.

As an example, Table 402 illustrates a plurality of segment data which includes 10,000 segments. Data metrics for each of the 10,000 segments can be determined, such as exemplary data metrics shown in table 402 in FIG. 4. Table 402 includes segment number 404 and data metrics for each segment, such as sparsity 406 (indicative of zero-valued elements divided by the total number of elements); the number of rows, 408, in the segment; the number of transactions, 410, in the segment; the average daily sales volume, 412, of the segment; the number of items, 414, in the segment; and the number of stores, 416, in the segment.

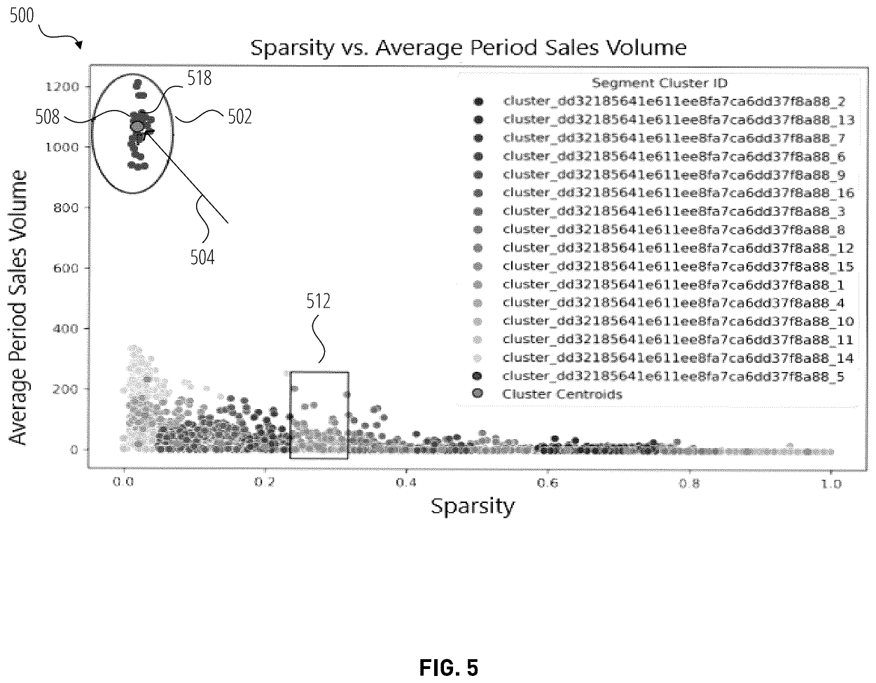

The segments listed in Table 402 can be used to determine clusters based on the data metrics. A simple example of clustered segments is shown in FIG. 5, wherein segments are clustered based on two of the data metrics, namely, sparsity and average period sales volume.

FIG. 5 illustrates exemplary clusters in a 2-dimensional graph 500 (Sparsity vs Average Period Sales Volume) and the corresponding centroid of each cluster, based on data table 402 in FIG. 4. Each data point represents a single segment which is corresponding to a single row in table 402 in FIG. 4. Graph 500 shows all 10,000 segments clustered into 16 groups, with a centroid of each cluster shown. For demonstrative purposes, cluster 502 and cluster 512 are highlighted.

The medoid of a cluster can be determined from the centroid of a cluster. The centroid can be determined, for example, by using a K-means centroid-based algorithm or a distance-based algorithm. Once the centroid is determined, the closest point to the centroid can be assigned as the medoid. With regards to FIG. 5, cluster 502 has a centroid 504; the closest data point to centroid 504 is selected and assigned as medoid 508 of the cluster 502. Data point 518 is a point adjacent to medoid 508, and may be used in the hyperparameter tuning process, as discussed further below.

A medoid is determined for all of the 16 clusters in graph 500. Clustering can be performed based on other data metrics (that is, other than sparsity and average period sales). Furthermore, clustering can be based on more than two data metrics.

The tuning of hyperparameters can be based on the segment data corresponding to a medoid of a cluster. For example, segment data can be selected corresponding to a medoid of a cluster, a hyperparameter optimization framework can be selected, and hyperparameters can be tuned accordingly. An example of a hyperparameter framework includes Optuna™.

FIG. 6 illustrates a block diagram 600 of a method for hyperparameter optimization in accordance with an embodiment.

The exemplary method, illustrated in FIG. 6, can be carried out by System 102 shown in FIG. 1. Alternatively, exemplary method (shown as in block diagram 600) may be carried out by another system, a combination of other systems, subsystems, devices or other suitable means provided the operations described herein are performed. Exemplary method shown in FIG. 6, may be automated, semi-automated and some blocks thereof may be manually performed.

Starting at block 602, block diagram 600 includes receiving a plurality of segmented data based on at least a first data attribute. At block 604, block diagram 600 includes processing the plurality of segment data for determining data metrics for each segment data. An example of determining data metrics of a plurality of segment data is illustrated in FIG. 4, that includes 10,000 segments. With respect to the example in FIG. 4, processing resource 106 can process each of the 10,000 segments, and determine data metrics for each of the 10,000 segments, such as exemplary data metrics shown in table 402 in FIG. 4. Table 402 includes segment number and associated data metrics, such as sparsity (indicative of zero-valued elements divided by the total number of elements), the number of rows in the segment, the number of transactions in the segment, the average daily sales volume of the segment, the number of items in the segment and the number of stores in the segment.

Next, at block 606, block diagram 600 includes clustering of data points indicative of the data metrics for each segment data for forming a plurality of clusters. Clustering can be performed based on more than two data metrics. One can extract various metrics and statistics from segments (for example, skewness, quantiles of quantity, percentage of time-series falling into each quantile, etc.) and cluster based on any combinations of data metrics. In some embodiments, metrics that intuitively result in high transferability of hyperparameters are chosen. For example, the number of rows in a segment is important since larger models are needed to train on them, which in turn, has an impact on the hyperparameters. On the other hand, the number of items in a segment has less of an impact on the hyperparameters. With reference to the example shown in FIG. 4, processing resource 106 can cluster data points indicative of data metrics shown in Table 402. Continuing with this example, a simple example of clustered data points is shown in FIG. 5, wherein data points are clustered based on sparsity and average period sales volume.

Next, at block 608, block diagram 600 includes determining a medoid for each cluster of segments. The medoid is defined as the most central data point in each cluster. The medoid can be determined as follows processing resource 106 can determine a centroid of the cluster. Next, processing resource 106 can select the closest point in the cluster to the centroid and may assigns it as the medoid of the cluster. This medoid is defined as a preliminary medoid, since the medoid used for tuning hyperparameters in tuning subroutine 618 can change. Block 608 is repeated for each cluster of the plurality of clusters. In the example shown in FIG. 5, there are a total of 16 clusters in graph 500; processing resource 106 can determine a medoid for each of the remaining 15 clusters.

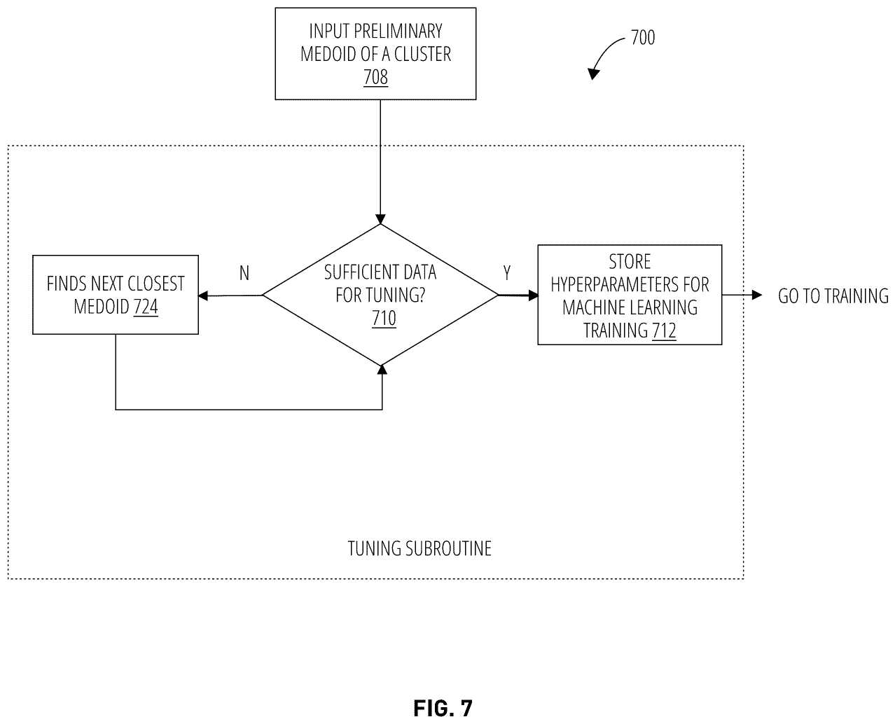

Block diagram 600 includes a tuning subroutine 618 for tuning hyperparameters of a cluster. An embodiment of tuning subroutine 618 is illustrated in FIG. 7. are For example, processing resource 106 can select segment data corresponding to a medoid of a cluster, select a hyperparameter optimization framework and tune the hyperparameters accordingly. An example of a hyperparameter framework includes Optuna™. The hyperparameters can be stored, for instance, in memory store 104. With regards to the example illustrated in FIG. 4 and FIG. 5, hyperparameter tuning is performed on segment data of 16 medoids, rather than all 10,000 segment data.

At block 619 block diagram 600 includes training a machine learning (ML) algorithm on each segment in the cluster, using the hyperparameters obtained from the tuning subroutine 618, for that cluster For example, processing resource 106 can train a model using segment data of a data point in the cluster and use the stored hyperparameters from tuning subroutine 618. The same algorithm is then trained on each of the remaining segment data in the cluster, using the same set of hyperparameters obtained from tuning subroutine 618 for the cluster. This results in a unique machine learning model associated with each segment in the cluster, based on one set of hyperparameters associated with that cluster.

Specific and non-limiting examples of machine learning models includes neural networks, decision trees, linear regression, and support vector machines, hidden Markov models, k-means, hierarchical clustering, Gaussian mixture models, temporal difference learning, deep adversarial networks, and Q-learning.

Next, at block 612, block diagram 600 includes determining whether there are more clusters to be processed. If there are more clusters to be processed block diagram 600 includes selecting a next cluster at block 614 and returning to tuning subroutine 618 to finalize the medoid hyperparameters of this next cluster. For example, processing resource 106 can select cluster 512 as shown in FIG. 5 as a next cluster to process, and proceeds to tuning subroutine 618 for tuning. If there are no remaining clusters for processing, block diagram 600 stops.

In the embodiment shown in FIG. 6, rather than tuning hyperparameters for all segment data, hyperparameter tuning is performed

Optionally and/or additionally, block diagram 600 includes forecasting at least a forecast item for each trained machine learning model at block 626. For example, referring again to segment data 300 and segment data 302 in FIG. 3, processing resource 106 can forecast at least one of items 1E, 1G and 1H, and one of items 1A, 1B, IC, ID and IF, respectively.

FIG. 7 illustrates a block diagram 700 of tuning subroutine in accordance with an embodiment.

At block 708, a preliminary medoid of a cluster is input to the tuning subroutine. The preliminary medoid can be obtained from block 608 of block diagram 600 in FIG. 6.

At decision block 710, block diagram 700 includes tuning hyperparameters based on the segment data corresponding to the preliminary medoid of the selected cluster. For each hyperparameter tuning trial based on segment data, cross-validation can be performed, in which a portion of the segment data is used for training, and the remaining portion is used to report the performance of the hyperparameters chosen for that round. This process can be repeated ‘K’ times, in what is commonly known as K-fold cross validation. The tuning algorithm can then use the information from initial and subsequent trials in an optimization algorithm to suggest the next best set of hyperparameters for the following trial, until termination.

As an example of the tuning process, processing resource 106 can select segment data corresponding to the preliminary medoid, select a hyperparameter optimization framework and tune the hyperparameters accordingly. An example of a hyperparameter framework includes Optuna™. The tuned hyperparameters can be stored, for instance, in memory store 104.

At decision block 710, block diagram 700 includes determining whether the segment data corresponding to the medoid is sufficient for hyperparameter tuning. For example, a hyperparameter optimization framework may return an error indicating insufficient data when using the segment data corresponding to the medoid. If there is sufficient segment data to perform hyperparameter tuning (‘yes’ at decision block 710), block diagram 700 moves to block 712, where the hyperparameters are stored for later use by a machine learning algorithm.

Alternatively, if there is insufficient segment data to perform hyperparameter tuning (‘no’ at decision block 710), block diagram 700 proceeds to block 724. At block 724, block diagram 700 determines the next closest data point to the current medoid, assigning the next closest data point as the medoid of the cluster, and returning to decision block 710. For example, with reference to FIG. 5, if segment data associated with medoid 508 is insufficient for hyperparameter turning, processing resource 106 may determine that data point 518 is the next closest data point to medoid 508. As such, processing resource 106 can assign data point 518 as the medoid of cluster 502.

Once a medoid is reassigned at block 724, the hyperparameters are tuned once more, though this time on the segment data associated with the new medoid-provided this segment data is sufficient for tuning. The loop 710-724-710 is carried out until a segment with sufficient data for tuning is found (‘yes’ at decision block 710) for the cluster. The resulting hyperparameters are stored at block 712 for machine learning training.

Once hyperparameters are tuned-that is, after block 712—the system proceeds to training a machine learning algorithm on each segment of the cluster at block 619 of FIG. 6.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
receive a plurality of segment data;
determine data metrics for each segment data;
cluster data points into a plurality of clusters, the data points indicative of a subset of the data metrics for each segment data;
determine a preliminary medoid of each cluster;
select a cluster;
tune a set of hyperparameters using segment data corresponding to a medoid of the cluster; and
train a machine learning model on each segment data in the cluster using the set of hyperparameters associated with the cluster.

2. The computing apparatus of claim 1, wherein when tuning the set of hyperparameters, the apparatus is configured to:
obtain the preliminary medoid of the cluster;
determine whether segment data associated with the preliminary medoid is sufficient for tuning;
where the segment data associated with the preliminary medoid is sufficient:
tune the set of hyperparameters on the segment data associated with the preliminary medoid; and
where the segment data associated with the preliminary medoid is insufficient:
sequentially select a data point adjacent to the preliminary medoid until segment data associated with the adjacent data point is sufficient for tuning; and
tune the set of hyperparameters on the segment data associated with the adjacent data point.

3. The computing apparatus of claim 1, wherein the preliminary medoid is a data point closest a centroid of the cluster.

4. The computing apparatus of claim 1, wherein the instructions further configure the apparatus to forecast an item using a trained machine learning model.

5. The computing apparatus of claim 1, wherein the machine learn model comprises: neural networks, decision trees, linear regression, and support vector machines, hidden Markov models, k-means, hierarchical clustering, Gaussian mixture models, temporal difference learning, deep adversarial networks, and Q-learning.

6. A non-transitory computer-readable storage medium, the computer-readable storage medium including instructions that when executed by a computer, cause the computer to:
receive a plurality of segment data;
determine data metrics for each segment data;
cluster data points into a plurality of clusters, the data points indicative of a subset of the data metrics for each segment data;
determine a preliminary medoid of each cluster;
select a cluster;
tune a set of hyperparameters using segment data corresponding to a medoid of the cluster; and
train a machine learning model on each segment data in the cluster using the set of hyperparameters associated with the cluster.

7. The computer-readable storage medium of claim 6, wherein tuning the set of hyperparameters comprises:
obtain the preliminary medoid of the cluster;
determine whether segment data associated with the preliminary medoid is sufficient for tuning;
where the segment data associated with the preliminary medoid is sufficient:
tune the set of hyperparameters on the segment data associated with the preliminary medoid; and
where the segment data associated with the preliminary medoid is insufficient:
sequentially select a data point adjacent to the preliminary medoid until segment data associated with the adjacent data point is sufficient for tuning; and
tune the set of hyperparameters on the segment data associated with the adjacent data point.

8. The computer-readable storage medium of claim 6, wherein the preliminary medoid is a data point closest a centroid of the cluster.

9. The computer-readable storage medium of claim 6, wherein the instructions further configure the computer to forecast an item using a trained machine learning model.

10. The computer-readable storage medium of claim 6, wherein the machine learn model comprises: neural networks, decision trees, linear regression, and support vector machines, hidden Markov models, k-means, hierarchical clustering, Gaussian mixture models, temporal difference learning, deep adversarial networks, and Q-learning.

11. A computer-implemented method comprising:
receiving, by a processor, a plurality of segment data;
determining, by the processor, data metrics for each segment data;
clustering, by the processor, data points into a plurality of clusters, the data points indicative of a subset of the data metrics for each segment data;
determining, by the processor, a preliminary medoid of each cluster;
selecting, by the processor, a cluster;
tuning, by the processor, a set of hyperparameters using segment data corresponding to a medoid of the cluster; and
training, by the processor, a machine learning model on each segment data in the cluster using the set of hyperparameters associated with the cluster.

12. The computer-implemented method of claim 11, wherein tuning the set of hyperparameters comprises:
obtaining, by the processor, the preliminary medoid of the cluster;
determining, by the processor, whether segment data associated with the preliminary medoid is sufficient for tuning;
where the segment data associated with the preliminary medoid is sufficient:
tuning, by the processor, the set of hyperparameters on the segment data associated with the preliminary medoid;
and
where the segment data associated with the preliminary medoid is insufficient:
selecting sequentially, by the processor, a data point adjacent to the preliminary medoid until segment data associated with the adjacent data point is sufficient for tuning; and
tuning, by the processor, the set of hyperparameters on the segment data associated with the adjacent data point.

13. The computer-implemented method of claim 11, wherein the preliminary medoid is a data point closest a centroid of the cluster.

14. The computer-implemented method of claim 11, further comprising forecasting an item using a trained machine learning model.

15. The computer-implemented method of claim 11, wherein the machine learning model comprises: neural networks, decision trees, linear regression, and support vector machines, hidden Markov models, k-means, hierarchical clustering, Gaussian mixture models, temporal difference learning, deep adversarial networks, and Q-learning.
